(19) United States
(12) Patent Application Publication
(10) Pub. No.: US 2015/0019262 A1
(43) Pub. Date: Jan. 15, 2015

(54) METHOD AND SYSTEM FOR GENERATING A FLASH FLOOD RISK SCORE

(71) Applicant: CoreLogic Solutions, LLC, Irvine, CA (US)

(72) Inventors: Wei DU, Springfield, VA (US); Thomas C. JEFFERY, Milton, WI (US); Howard BOTTS, Madison, WI (US)

(73) Assignee: CoreLogic Solutions, LLC, Irvine, CA (US)

(21) Appl. No.: 13/939,806

(22) Filed: Jul. 11, 2013

(51) Int. Cl. G06Q 40/08

(52) U.S. Cl. CPC G06Q 40/08
USPC 705/4

(57) ABSTRACT

Computer-based systems and methods are disclosed for modeling and predicting flash flood risks for real estate properties. In some embodiments, the systems and methods can predict flash flood risks for real estate properties by considering a variety of factors, including watershed hydrology characteristics, land surface characteristics, meteorological characteristics, and/or property characteristics. In some embodiments, the systems and methods can improve determination of investment metrics or automated valuations by considering flash flood risks in determining the investment metrics or automated valuations.

### BACKGROUND

1. Field

The present disclosure relates to computer processes for predicting flash flood risks for a property.

2. Description of the Related Art

Based on National Oceanic and Atmospheric Administration's definition, flash floods are short-term events, occurring within 6 hours of the causative events (such as heavy rain, dam break, levee failure, rapid snowmelt, and ice jams) and often within 2 hours of the start of high intensity rainfall. Flash floods can move at incredible speeds, tear out trees, destroy buildings and bridges, and could raise killing walls of water up to 10-20 feet. Flash flooding can also be a leading cause of weather-related deaths. In addition, because of the randomness of flash flood distribution and shortage of historical data, risk assessment for flash flooding can be difficult.

Among federal, public, and private measures on flash flood loss mitigation, insurance and reinsurance may be a key factor in reducing the financial risk to individuals, enterprises, and even whole societies. Mortgage companies, public sector (from FEMA to municipalities), capital markets, insurance, and reinsurance companies may need knowledge about frequencies of flash floods, and frequencies of flash flood losses at different property locations in order to underwrite sufficient and comprehensive policies for these properties.

The most public-available flood risk information in the United States is from Federal Emergency Management Agency (“FEMA”) and its Flood Insurance Studies (“FIS”), which were scoped and conducted based on visible surface water bodies (such as rivers, ponds and lakes, and oceans), but not efforts on “dry land.” Traditionally flood risk for both residential and commercial properties may have been determined by whether the properties were inside or outside FEMA Special Flood Hazard Areas (SFHAs) within the United States. Whether the property is inside or outside of an SFHA may have been the principle risk factor considered in determining whether to purchase flood insurance. However, SFHAs are only small part of geographic areas of our communities. Logically, 100 year heavy rainfall can lead a 100 year flood in river systems and raise the flood inundation to SFHA boundaries. It must be realized that 100 year rainfall could also cause severe flash flooding in the areas beyond SFHAs because all surrounding areas (such as A zones, X500 zones, and X zones) may receive the same amount of heavy precipitation during the severe storm events.

In addition, in existing methods, studies, and analytical tools, risk indicators for the flash flooding either solely focus on meteorological factors (such as precipitation, storm moving speed, relative humidity, and wind direction) or land surface characteristics (such as land slope, soil types, land use and forest coverage). However, focusing solely on these factors may not provide an accurate prediction of flash flooding. Land slope, for example, has been used in the existing studies for determining the flash flooding potential. It has to be realized that large land slopes can promote flash flooding occurrence, but flash flooding wouldn't necessarily happen where land slopes are steep. Moreover, often, predictions or warnings on the flash flooding were given at a large geography (such as county level) and cannot specify the detailed locations and times. Furthermore, in some existing methods, studies, and analytical tools, indicators for flash flooding focus on simulating the physical happenings at specific locations when flash floods may occur. However, focusing solely on the simulations may not provide an accurate and efficient prediction of flash flooding risks.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to generate a flash flooding risk model.

FIG. 2 is a schematic diagram illustrating an aspect of the flash flooding risk model that provides an overall flash flooding risk of real estate properties.

FIG. 3 is a block diagram that illustrates an example of a process for calculating flow direction for real estate properties.

FIG. 4 is a block diagram that illustrates an example of a process for calculating flow accumulation for real estate properties.

FIG. 5 is a block diagram that illustrates an example of a categorization for flash flooding for risks real estate properties based at least in part on flow accumulation.

FIG. 6 is a schematic diagram illustrating an aspect of the flash flooding risk model for real estate properties that provides consideration of hydraulic expansion.

FIG. 7 is a block diagram that illustrates an example of a process for calculating hydraulic expansion.

FIG. 8 is a block diagram that illustrates an example of a categorization for flash flooding for risks for real estate properties based at least in part on average land slope.

FIG. 9 is a block diagram that illustrates an example of a process for calculating flash flood risk based at least in part on watershed hydrology characteristics and land slope characteristics.

FIG. 10 is a block diagram that illustrates an example of a categorization for flash flooding for risks for real estate properties based at least in part on imperviousness of land use.

FIGS. 11A, 11B, and 11C are block diagrams that illustrate examples of a categorization for flash flooding for risks for real estate properties based at least in part on soil properties.

FIG. 12 is a block diagram that illustrates an example of a categorization for flash flooding for risks for real estate properties based at least in part on forest coverage.

FIG. 13 is a block diagram that illustrates an example of a categorization for flash flooding for risks for real estate properties based at least in part on rainfall intensity.

FIG. 14 is a flowchart illustrating a method of calculating a flash flooding risk score in accordance with an embodiment.

FIG. 15 is a schematic diagram illustrating an aspect of the flash flooding risk score that provides an overall flash flooding risk of real estate properties.

FIG. 16 is a flowchart illustrating as method of building a flash flooding risk model in accordance with an embodiment.

FIG. 17 is a flowchart illustrating an example of a method for determining valuations for real estate properties using a flash flooding risk model.

FIG. 18 is a flowchart illustrating an example of a method for determining investment metrics for real estate properties using a flash flooding risk model.

### DETAILED DESCRIPTION

Various aspects of the disclosure will now be described with regard to certain examples and embodiments, which are intended to illustrate but not to limit the disclosure.

Computer-based systems and methods are disclosed for modeling and predicting flash flood risks for real estate properties. In some embodiments, the systems and methods can predict flash flood risks for real estate properties by considering a variety of factors, including watershed hydrology characteristics, land surface characteristics, meteorological characteristics, and/or property characteristics. In some embodiments, the systems and methods can improve determination of investment metrics or automated valuations by considering flash flood risks in determining the investment metrics or automated valuations. In some embodiments, a confidence score and/or error rate, such as a forecast standard deviation (“FSD”) may be calculated to provide information about the relative error rate inherent in any market prediction.

In various embodiments, a flash flood risk score may be determined for a property point (e.g., a specific coordinate location, a parcel, an address, etc.) that provides a comprehensive assessment of the property point's risk of flash flooding. As used herein, “property point” may refer to an entire property (e.g., designated by an address), a geocoded point location defined using geospatial coordinates (e.g., a latitude and a longitude), a georeferenced point (e.g., referenced to a coordinate system and/or specific coordinate locations on a property), different latitude/longitude coordinate locations corresponding to specific points on a property, a specific building on the property, etc. Other property point types (e.g., other points of interest are also contemplated.

Further, determining the flash flood risk score may include determining one or more flash flood risk characteristics for the property point and assigning a flash flood risk score that corresponds to the one or more flash flood risk characteristics. In some embodiments, flash flood risk characteristics may include watershed hydrology characteristics, land surface characteristics, meteorological characteristics, and/or property characteristics. For example, a first flash flood risk characteristic and a second flash flood risk characteristic may be used to assign a first score component and a second score component, respectively, that may be summed together to form a flash flood risk score. Other numbers of components (e.g., for considering additional flash flood risk characteristics) are also contemplated. Other ways of combining the score components are also contemplated (e.g., the score components may be averaged or weighted together). In various embodiments, the flash flood score may be used by one or more analysis applications, such as automated valuation applications, investment metric calculation applications, etc. to provide estimates that take flash flooding risks into consideration.

Implementations of the disclosed systems and methods will be described in the context of determining and/or predicting flash flood risks, determining investment metric(s), determining automated valuation(s), determining confidence score(s), and so forth for real estate properties. This is for purposes of illustration and is not a limitation. For example, implementations of the disclosed systems and methods can be used to find flash flood risks for any type or property, such as for commercial property developments such as office complexes, industrial, or warehouse complexes, retail and shopping centers, and apartment rental complexes, and for vehicles, such as automobiles, boats, etc. In addition, although the determined flash flood risks found by various implementations of the systems and methods described herein can be used to provide automated valuations, the flash flood risks can also be provided to and used by real estate brokers, real estate appraisers, and the like to perform manual valuations of a subject property.

### Example

### Real Estate Flash Flooding Risk Determination System

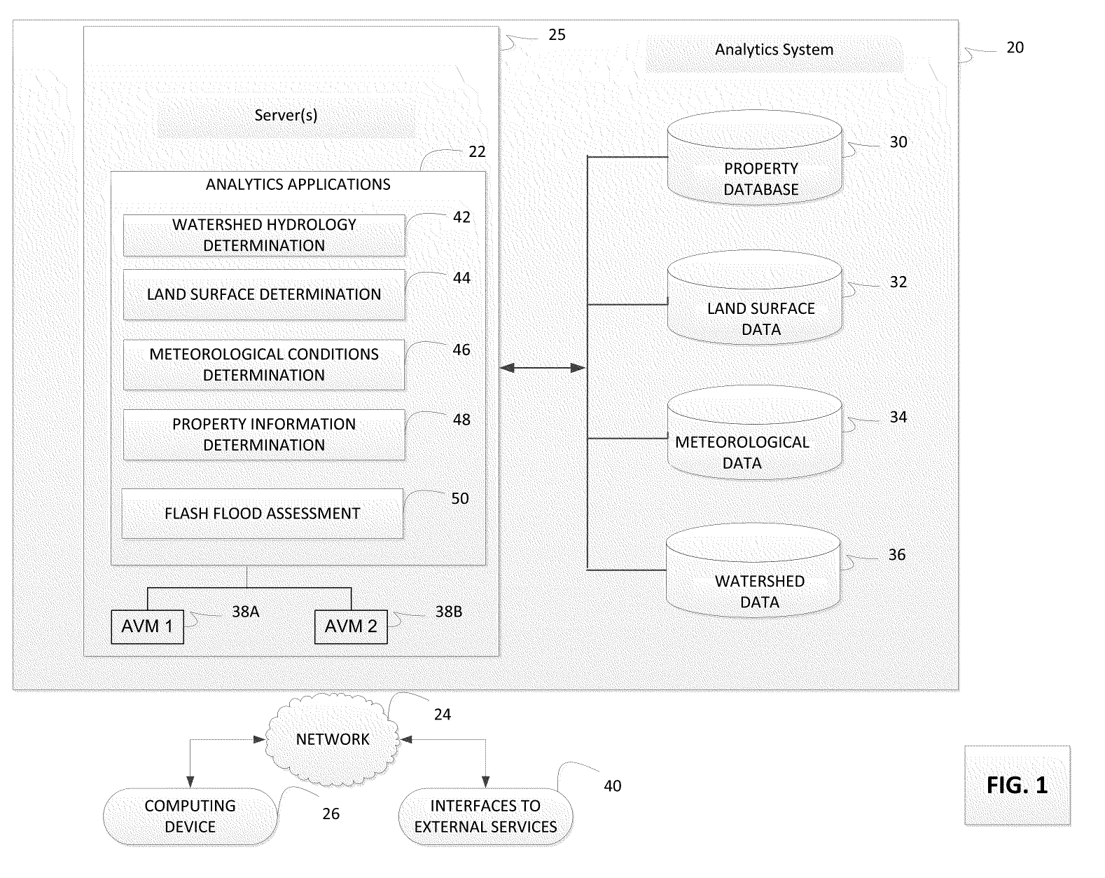

FIG. 1 illustrates an analytics system 20 according to one embodiment. The system may be provided by a business entity or “analytics provider” that provides various services to its customers for assessing investment opportunities associated with real estate properties. As illustrated, the system includes a set of analytics applications 22 that are accessible over a network 24 (such as the Internet) via a computing device 26 (desktop computers, mobile phones, servers, etc.). Typical customers of the system 20 include mortgage lenders, other types of lenders, insurance companies, real estate investors, real estate brokers, and real estate appraisers.

As illustrated, analytics applications 22 use a set of data repositories 30-36 to perform various types of analytics tasks, including tasks associated with flash flood risk assessments. In the illustrated embodiment, these data repositories 30-36 include a database of property data 30, a database of land surface data 32, a database of meteorological data 34, and a database of watershed data 36. Although depicted as separate databases, some of these data collections may be merged into a single database or distributed across multiple distinct databases. Further, additional databases containing other types of information may be maintained and used by the analytics applications 22. As shown in FIG. 1, each analytic application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLSs) contain data intended for realtors, and can be contacted and queried through a network such as the Internet. Such data may then be downloaded for use by embodiments of the present invention. Other examples include retrieving data from databases/websites such as Redf in, Zillow, etc. that allow users to directly post about available properties. Furthermore, property database 30 may contain aggregated data collected from public recorder offices in various counties throughout the United States. This database 30 can include property ownership information and sales transaction histories with buyer and seller names, obtained from recorded land records (grant deeds, trust deeds, mortgages, other liens, etc.). In one embodiment, the analytics provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 is preferably updated on a daily or near-daily basis so that it closely reflects the current ownership statuses of properties throughout the United States. In one implementation, the database 30 covers 97% of the sales transactions from over 2,535 counties.

The database of land surface data 32 contains land surface data obtained from one or more of the entities, such as United States Geological Survey (“USGS”), National Land Cover Database (“NLCD”), U.S. Department of Agriculture (“USDA”), National Resources Conservation Service (“NRCS”), that include land surface data associated with real estate properties. Land surface data can include land surface characteristics (e.g., catchment slope, hydrological properties, infiltration of soils, imperviousness of land use, interceptions of forest coverage, etc.) of the land that a property resides on. The database of meteorological data 34 contains meteorological data obtained from one or more of the entities, such as National Weather Service (“NWS”), Weather Services International (“WSI”), USGS, National Climatic Data Center (“NCDC”, National Oceanic and Atmospheric Administration (“NOAA”), that include meteorological data associated with real estate properties. Meteorological data can include meteorological characteristics (e.g., rainfall distribution, rainfall frequency, rainfall intensity, etc.) of the region that a property resides on. The database of watershed data 36 contains watershed data obtained from one or more of the entities, such as USGS, that include watershed data associated with real estate properties. Watershed data can include watershed hydrology characteristics (e.g., physical features of bodies of water and the land areas that are affected by those bodies of water, etc.) in the watersheds that a property resides on.

As further shown in FIG. 1, the system 20 may also include one or interfaces 40 to other (externally hosted) services and databases. For example, the system may include APIs or other interfaces for retrieving data from LexisNexis, Merlin, MERS, particular real estate companies, government agencies, and other types of entities.

As further shown in FIG. 1, the analytics applications 22 include a “watershed hydrology determination” application or application component 42 (hereinafter “application 42”). As explained below, this application or component 42 uses some or all of the data sources described above to identify watershed hydrology characteristics associated with real estate properties. Such watershed hydrology characteristics may be used for various flash flood risk-assessment-related or due diligence purposes. For example, insurance companies may use such information to determine insurance risks for a particular property. As another example, one or more of the analytics applications 22 may use an individual's property watershed hydrology characteristics, together with other information regarding the individual property, to determine a flash flood risk score for the property.

The analytics applications 22 also include a “land surface determination” application or application component 44 (hereinafter “application 44”). As explained below, this application or component 44 uses some or all of the data sources described above to identify land surface characteristics associated with real estate properties. Such land surface characteristics may also be used for various flash flood risk-assessment-related or due diligence purposes and/or to determine a flash flood risk score for the property.

The analytics applications 22 further include a “meteorological conditions determination” application or application component 46 (hereinafter “application 46”). As explained, this application or component 46 uses some or all of the data sources described above to identify meteorological characteristics associated with real estate properties. Such meteorological characteristics may also be used for various flash flood risk-assessment-related or due diligence purposes and/or to determine a flash flood risk score for the property.

The analytics applications 22 further include a “property information determination” application or application component 48 (hereinafter “application 48”). As explained, this application or component 48 uses some or all of the data sources described above to identify property characteristics associated with real estate properties. Such property characteristics may also be used for various flash flood risk-assessment-related or due diligence purposes and/or to determine a flash flood risk score for the property.

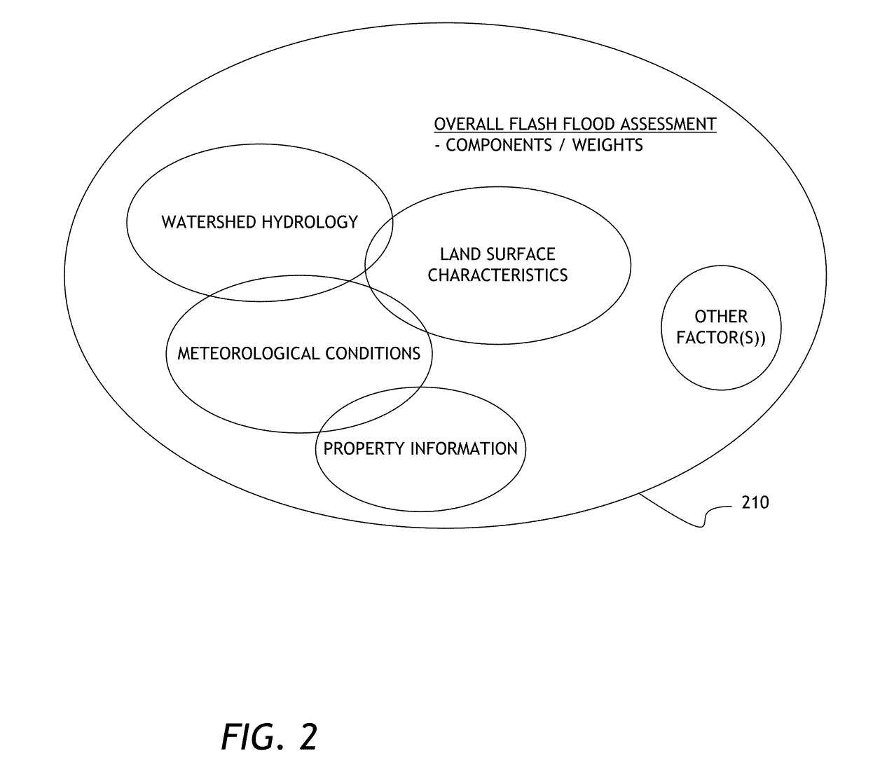

The analytics applications 22 further include a “flash flood assessment” application or application component 50 (hereinafter “application 50”). As explained below application or component 50 can communicate with applications 42, 44, 46, or 48, to determine a flash flood risk, flash flood risk score, valuation, investment metric, etc. for the particular property of group of properties. For example, application 50 can communication with AVM1 38A or AVM2 38B to determine an automated valuation for the particular property of group of properties. The flash flood risk, flash flood risk score, valuation, investment metric, etc. for a property of group of properties may be determined in response to a request or can be determined on a periodic basis. The request may come from a user while the user is located at the particular property or group of properties. The request can include identification information associated with a property point. The flash flood risk, flash flood risk score, valuation, investment metric, etc. for a property of group of properties may be determined prior to any flash flooding risk/potential and/or independent of any occurrence that may lead to flash flooding. In some embodiments, additional data may be provided by entities or users over network 24 that may also be considered by application 50 in the determination of a flash flood risk score. For example, in one embodiment, computing device 26 may comprise a mobile device, such as a Smartphone, Global Positioning System (“GPS”) unit, laptop, tablet, etc., that is carried by a user at the particular property or group of properties of interest. The user may use the computing device 26 to provide data, such as GPS coordinates, images, video, descriptions, comments, characteristics, or the like that is used by application 50 in the determination of the flash flood risk score. The additional data may be provided interactively by the user via a webpage, mobile application, etc. Similarly, the determined flash flood risk, flash flood risk score, valuation, investment metric, etc. may be provided to a requesting entity/device or may be stored in a data repository. As illustrated in FIG. 2, an overall flash flood assessment 210 can based on a variety of factors, including watershed hydrology, land surface characteristics, meteorological conditions, property information, etc. Each of these factors will be further explained below.

### Watershed Hydrology Determination

Application 42 may be configured to determine watershed hydrology characteristics that can be used to identify flash flood risks for real estate properties. Scientifically, flash flooding can result from overland runoff accumulation within a short time period. Because of the gradients of land elevation, the earth gravity may force overland flow moving from higher land areas to lower land areas. As a result, the areas having a higher flow accumulation may have higher flash flooding potential. Data sources containing initial flood map datasets (e.g., datasets from flood elevation lines or from flood elevation raster images) may be accessed to determine watershed hydrology characteristics. Additional data may be derived from 1-10 m Digital Elevation datasets (“1-10 m” may indicate a resolution of the maps), USGS gage station records, and flood source features from USGS National Hydrologic Datasets.

Other resolution (e.g., higher resolution) digital elevation datasets are also contemplated. The most common digital data of the shape of the earth's surface is cell-based digital elevation models (DEMs). This data can be used as input to quantify the characteristics of the land surface to be used to identify watershed hydrology characteristics. A DEM is a raster representation of a continuous surface, usually referencing the surface of the earth. A DEM can be represented as a grid of cells. The accuracy of this data is determined primarily by the resolution (the distance between sample points). Other factors affecting accuracy are data type (integer or floating point) and the actual sampling of the surface when creating the original DEM. There can be two steps to calculate the flow accumulation by using the DEM: (1) the determination of flow direction; and (2) computation of flow accumulation. Flow across a surface may be in the steepest downslope direction. Once the direction of flow out of each cell of a DEM is known, it can be possible to determine which and how many cells flow into any given cell. This information can be used to define watershed boundaries and stream networks.

Flow Direction

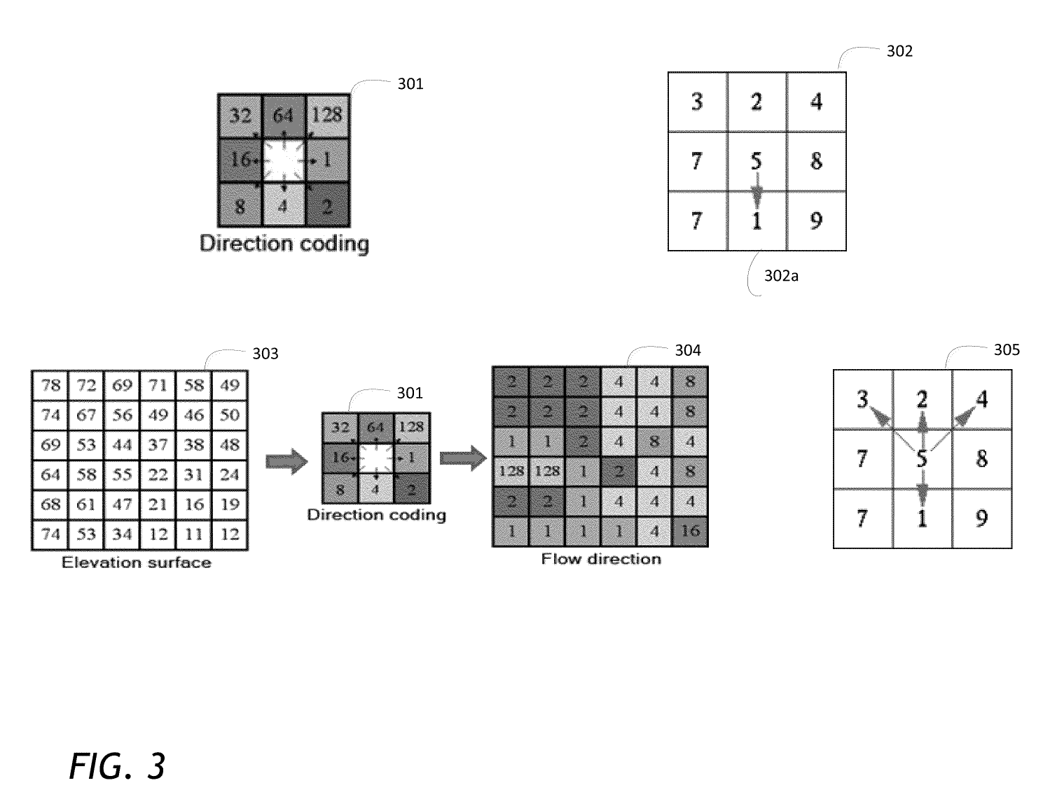

The first step of determining flow direction is to detect watersheds associated with the real estate properties. A watershed is the upslope area contributing flow to a given location. Such an area can also be referred to as a basin, catchment, subwatershed, or contributing area. A subwatershed is simply part of a hierarchy, implying that a given watershed is part of a larger watershed. The watersheds may be detected by accessing data sources indicated above. For example, data sources from USGS may be accessed to determine watershed regions. Alternatively, data sources from USGS may be accessed to determine catchment areas, sub-watershed polygons, or any other region mappings of interest. DEMs then in those watershed regions or other regions of interest may be analyzed to determine the flow direction. DEM data files are digital representations of cartographic information in a raster form. DEMs consist of a sampled array of elevations for a number of ground positions at regularly spaced intervals (e.g., grids). These digital cartographic/geographic data files can be sold in 7.5-minute, 15-minute, 2-arc-second (also known as 30-minute), and 1-degree units. As an example, the DEMs in the watershed regions may be analyzed in view of flow direction coding grids to determine the flow direction. Flow direction coding grids can be computed to analyze land elevation values for each direction from a point associated with the detected watershed regions. FIG. 3 details an example of a flow direction coding grid 301. As shown, the flow direction coding grid can have eight direction codes. After generation of a flow direction coding grid, the DEMs for the watershed regions can be analyzed to substitute values from the flow direction coding grids to indicate the flow direction. For example, DEM 302 provides example of elevation levels obtained from the data sources discussed above. Two different methods can be used to analyze the DEM 302 in view of the flow direction coding grids.

First, the DEM can be analyzed to detect flow direction in a single direction. For instance, from the center of DEM 302 (e.g., value=5), it can be seen (as illustrated), the lowest elevation point connected to the center is directly below the center (e.g., value=1). Based on the flow direction coding grids, a value of 4 (which corresponds to the direction of lowest elevation) can be substituted for the center of the DEM 302 which results in a grid detailing flow directions. The single direction process may be effective for catchment area boundary or stream line delineation, because the process can narrow the searched directions to the lowest downhill grid quickly. FIG. 3 illustrates another example of the single direction detection process. A data set 303 includes elevation values for each point in the grid. Analyzing the data set 303 in a single direction and using the flow direction coding grid 301, the resulting flow direction grid 304 is identified. As shown, for the elevation level “12” in the data set 303 (e.g., bottom right), the lowest elevation point that is connected to the point in the grid has the elevation value of 11 that is located directly to the left. Based on the flow direction grid 301, a value of “16” may be substituted in the resulting flow direction grid 303. Similar analysis may be performed for each point in data set 303 to result in flow direction grid 304.

Alternatively (or in combination with the single direction process), the watershed can be analyzed to detect flow direction in multiple directions. FIG. 3 illustrates an example of the multiple direction detection process. The process records all lower elevation directions (in contrast to the lowest) based on elevations in surrounding points in the grid. For instance, for the DEM 305, 4 different directions from the center of the watershed (as illustrated) would be noted as having lower elevation values. Subsequently, the flow direction coding grid 301 may be used to substitute values to result in a resulting flow direction grid (e.g., 32, 64, 128, and 1 could be substituted for the center point in the grid). Similar analysis may also be performed for each point in a data set. The multiple direction process may be helpful to assess flow accumulation in all possible directions. In some embodiments, depression areas in DEMs have to be filled to stop flow accumulation at the depression areas. The DEM dataset can be converted to be a depression-free DEM (e.g., hydro-DEM) prior to computing the flow direction.

Flow Accumulation

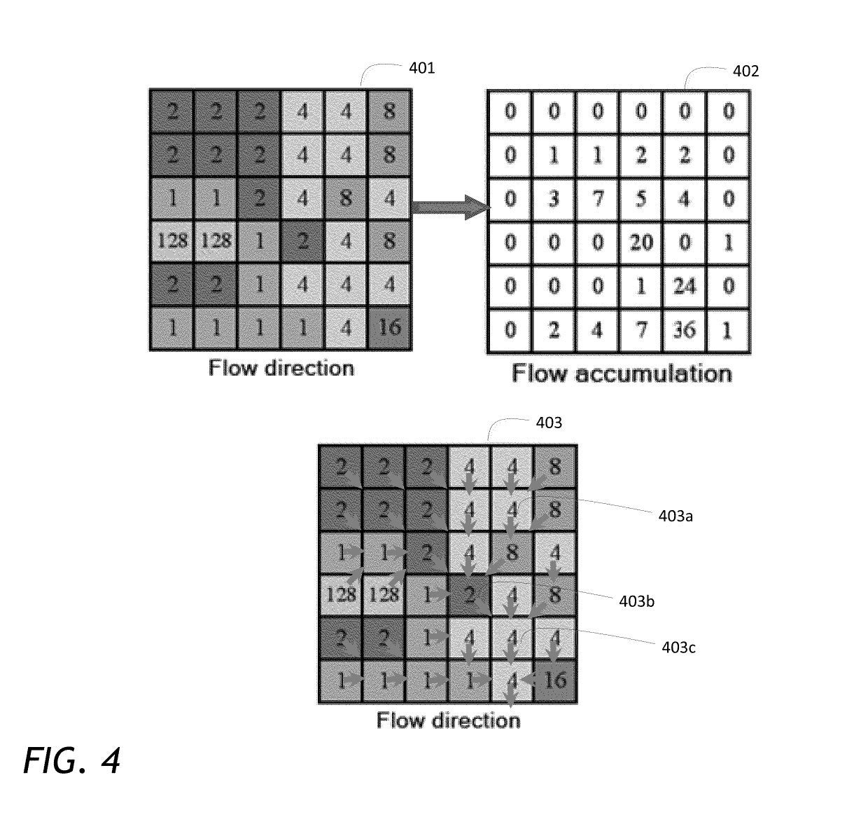

After identifying the flow direction, as discussed above, the flow accumulation (“FAC”) of a watershed region may be computed. Flow accumulation grids may be computed based at least in part on the computed flow direction grids. As illustrated in FIG. 4, the accumulated flow for each cell in a flow accumulation grid 402 may be computed by accumulating the weighted flow for all cells that flow into each downhill cell of the computed flow direction grid 401. For the single flow direction based FAC computation, downhill cell (the lowest path) will receive 100% flow from the upstream cell; For the multiple direction based FAC computation, the distribution of flow from the current cell to downhill cells may be illustrated as:

Outgoing FAC=ΣWᵢ*(Incomming FAC+flow at the current cell)

The weight (Wᵢ) can be determined by different methods (such as land slope to different directions). In some embodiments, ΣWᵢ=1, which means incoming and outgoing flow may have to be balanced. In some embodiments, the final accumulated value can also be rounded to be an integer. As an example, flow accumulation grid 402 may be computed from flow direction grid 401 by first virtually indicating the direction of flow in the flow direction grid as shown in annotated flow direction grid 403. Annotated flow direction grid 403 includes arrows showing the direction of water flow based on the flow direction grid 301. After creation of the annotated flow direction grid 403, flow accumulation grid 402 may be computed by calculating for each target cell the sum of: (1) number of adjacent cells that have a flow direction directed to the target cell; (2) total flow accumulation values for the adjacent cells that have a flow direction directed to the target cell. For example, for the first row and first column of annotated flow direction grid 403, there are not any adjacent cells with arrows (e.g., flow direction) directed to the cells in the first row or column. As a result, a flow accumulation value of zero would be computed as shown in flow accumulation grid 402. As another example, for cell 403a, there are two adjacent cells with arrows directed to cell 403a. In addition, since those two adjacent cells are in the first row and had a zero value for flow accumulation in flow accumulation grid 402, the resulting flow accumulation for cell 403a, as shown in flow accumulation grid 402, would have a value of 2 (e.g., 2+0). As yet another example, for cell 403b, there are four adjacent cells with arrows directed to cell 403b. From flow accumulation grid 402, these four adjacent cells have a total flow accumulation of 16 (e.g., 4+5+7+0). As a result, the resulting flow accumulation for cell 403b, as shown in flow accumulation grid 402, would have a value of 20 (e.g., 4+16). As a further example, for cell 403c, there are three adjacent cells with arrows directed to cell 403c. From flow accumulation grid 402, these three adjacent cells have a total flow accumulation of 21 (e.g., 1+0+20). As a result, the resulting flow accumulation for cell 403c, as shown in flow accumulation grid 402, would have a value of 24 (e.g., 3+21).

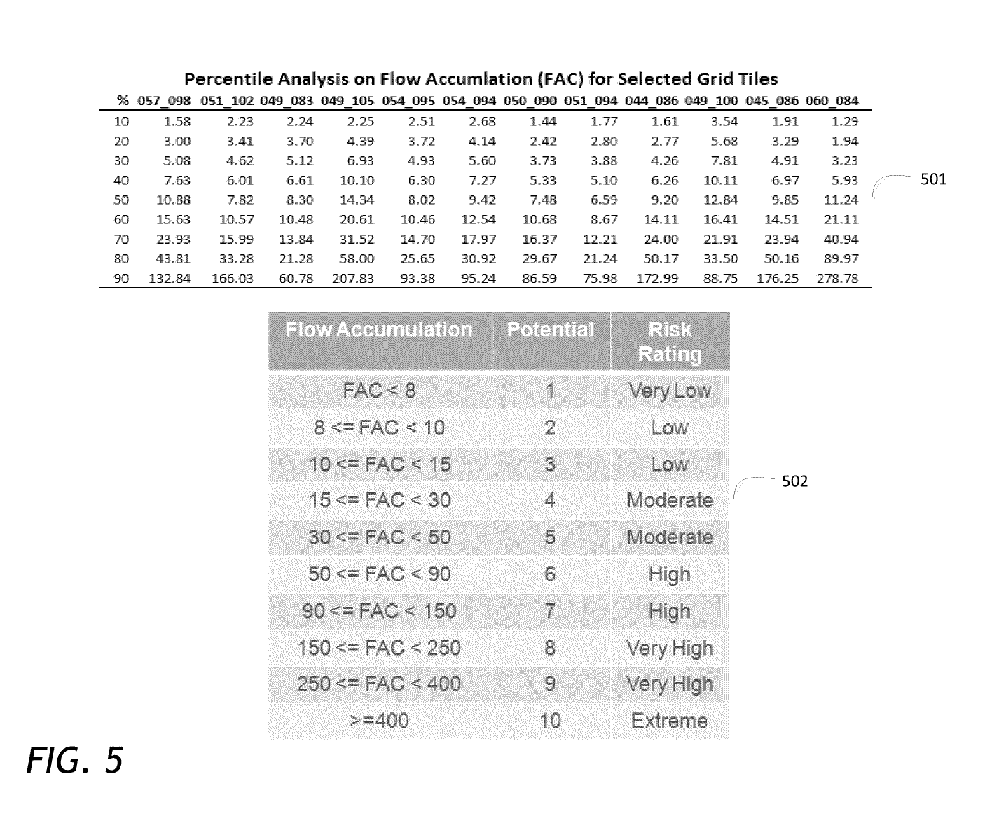

Flow accumulation values may be calculated for each hydrological region, basin, watershed, and/or catchment area in the United States or any other country/region. The resulting calculation of flow accumulations for DEMs can be stored in a data repository for use in a variety of applications including, flash flood risk determinations (discussed below), landslide predictions, transportation network outage predictions, sewer backup predictions, and many others. Flow accumulation values, in some embodiments, may also be categorized based on their severity or sensitivity relative to flash flooding risk. To determine the categorization, historical sites for flash flooding may be analyzed by calculating the flow accumulation for various points at the sites as discussed above. The calculated values of the flow accumulation then may be statistically analyzed to identify the categorization for flow accumulation values. For example, FIG. 5 illustrates an example table 501 of flow accumulation values at various historical sites that had flash flooding. From analyzing the table, it can be estimated that the categories shown in categorization table 502 can be identified. For instance, 30% of the points at the historical sites had FAC values of less than 8. Therefore, this grouping can be identified a very low category. Similar analysis may be applied to identify the other categories. A variety of other categorization methods are also contemplated by embodiments of the present invention. In some embodiments, one or more risk scores and/or indicators relating to the risk of flash flooding from flow accumulation or other watershed hydrology characteristics may be generated. The risk scores may be generated using the categorization process discussed above. For example, a risk score of “1” can be given to the very low category and a risk score of “10” for the extreme category as illustrated in FIG. 5. Other variations for generating risk scores are possible in embodiments the present invention.

Hydraulic Expansion

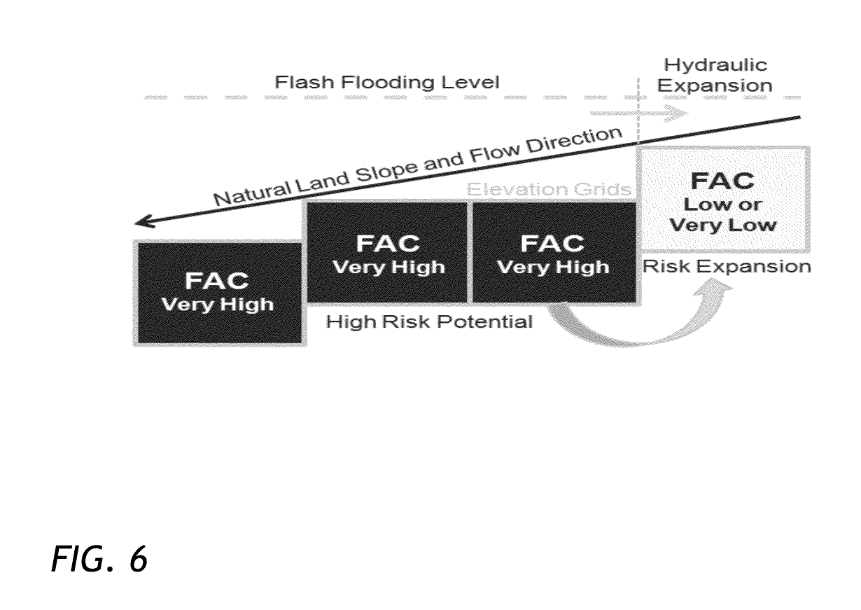

As a physical law, water flows from a higher land elevation to a lower land elevation due to earth gravity. The flow accumulation computation above was based on this natural law/land slope to count the accumulation of the volume of water flow. However, during flash flooding events, the water depth in the area with high flow accumulation will be increased. As result, water could flow to the area with high elevation and low flow accumulation based on hydraulic gradients because of the water depth increase. In other words, water could flow from the area with lower land elevation to higher land elevation, against land slopes/gravity. With the hydraulic expansion, as illustrated in FIG. 6, flash flooding risk potential from the cells with high flow accumulation could be pushed into the adjacent cells with low flow accumulation. To account for this phenomenon, adjustments could be made to the calculated flow accumulation values.

To simulate flash flooding risk for expanding from high risk cells to low risk cells, a derived FAC value could be determined to replace the FAC value in low risk cells by the following formula:

FAC Receiving=μ*FAC Expanding

When FAC Expanding>=FAC Risk Threshold and FAC adjacent<=FAC Moderate Risk or Less

Where μ is an expansion parameter with a value between 0 and 1.

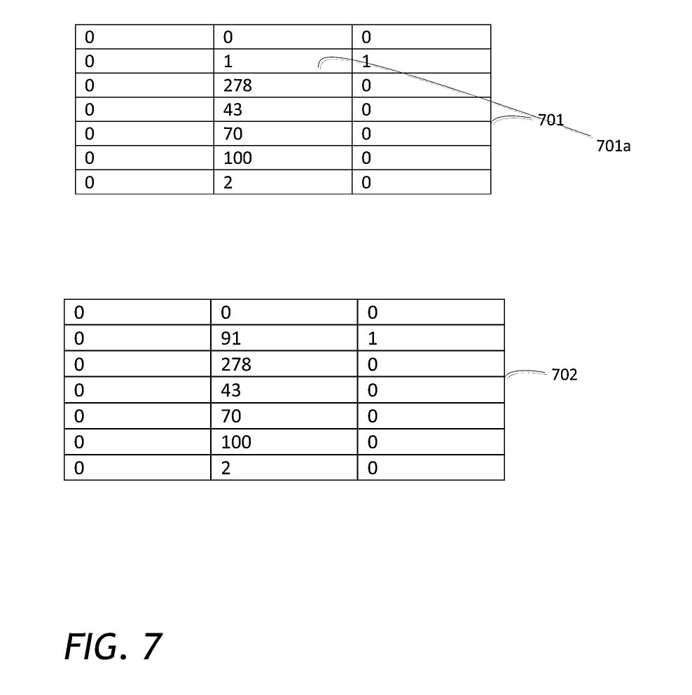

One objective of implementing hydraulic expansion method is not to try calculating true hydraulics between two adjacent cells but to push adjacent cells with low FAC to higher category of flash flooding risk. For example, as illustrated in the categorization table 502 in FIG. 5, the very low and low categories of flow accumulation have FAC values up to “10.” These categories of flow accumulation would be candidates for hydraulic expansion from adjacent higher risk cells. For instance if any cells had FAC values of higher than “150” (categorized as very high or extreme), and were adjacent to the lower risk cells, the FAC values of the lower risk cells may be adjusted higher to account for the increase in flow accumulation from hydraulic expansion. As noted above, the FAC values for the lower risk cells may be replaced by a value calculated by the formula above to push the lower risk cells to a higher category. As an example, if FAC Expanding is given a value of 150 (e.g., lowest value for very high or extreme categories from FIG. 5), and FAC Receiving was given a value of 50 (e.g., an FAC value from a higher category that can be used to replace FAC values of lower risk cells), then μ can be determined to be 0.33. Based on the calculated expansion parameter, any FAC values for low risk grids that are adjacent to high risk grids may be replaced by FAC values that are calculated by multiplying the calculated expansion parameter and the FAC value of the higher risk cells. FIG. 7 illustrates an example hydraulic expansion calculation. Table 702 illustrates an example output from calculation of a flow accumulation as discussed above. As illustrated, tile 701a has a low FAC value but is adjacent to a cell that has a very high FAC value. Flow accumulation from the very high cell may flow to the cell with very low flow accumulation. To account for this phenomenon, the FAC value may be adjusted by multiplying the very high FAC value with the expansion parameter. In the illustrated example, the FAC value can be adjusted to 91 (e.g., 278*0.33). Similar adjustments may be made to other cells.

In some embodiments, the computation procedure of the hydraulic expansion could be carried out to four adjacent and directly facing cells from a targeted cell. In addition, in some embodiments, tiered adjustments could be applied based on the severity of the higher calculated values of potential flow accumulation. Further, the hydraulic adjustments, in some embodiments, may be applied recursively or in multiple cycles to make higher adjustments based on the accuracy of results of the predictions. A variety of other computations and/or adjustments can be calculated by embodiments of the present invention to account for hydraulic expansion. The categorization and risk scores discussed above may also be adjusted in view of any identified hydraulic expansions.

Land Surface Determination

Application 44 may be configured to determine land surface characteristics that can be used to identify flash flood risks for real estate properties. Land surface characteristics can include any characteristics that may impact flash flood risks, such as land slope, soil properties, imperviousness of land use, forest coverage, vegetation coverage, land depression areas, wildfire burned areas, etc. These land surface characteristic can determine surface runoff creation potential from any rainfall. Data sources containing land surface characteristics data, such as NRCS, USDA, USGS, NLCD, may be accessed. Some of the land surface characteristics that may impact flash flood risk will be discussed below.

Land Slope

Land slope promotes downhill movement of water over the land surface which can quickly accumulate to become a potential a flash flooding hazard. Large land slopes can intensify hydraulic force on the overland flow and cause destructions of properties and life losses. Hilly land surfaces may provide higher flash flooding potential. However, the locations where land slopes are relatively high are not always where flash flooding would occur. For example, flash flooding may form in the bottom of valleys rather than in hill sides where land slopes are steep. Therefore, simply using the land slope value at each grid (point) may not always be effective to describe the flash flooding potential. To solve the problem, in some embodiments, average land slopes of hydrologic catchment areas to reflect the contribution of land slopes from watersheds to the flash flooding risk may be used. Catchment areas comprise part of the surface of the earth that is occupied by a drainage system, which can include a surface stream or a body of impounded surface water together with all tributary surface streams and bodies of impounded surface water. Listing of catchment areas may be provided by third party entities, such as the USGS. Land elevation grids (e.g., DEMs) from third party entities, such as USGS, may be accessed for the catchment areas and then analyzed to determine average slopes in the catchment areas and its impact on flash flooding risks. To calculate the average land slope in the catchment areas, first the land elevation grids in the catchment areas may be analyzed to compute land slope grids for the catchment areas. Then the land slope grids may be statistically analyzed to compute the average land slope in the catchment areas.

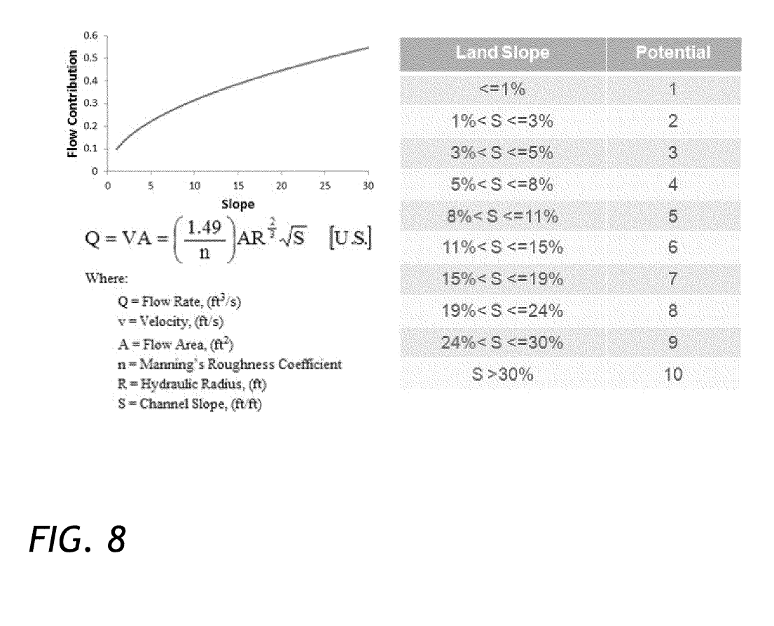

Average land slope values may be calculated for each catchment area in the United States or any other country/region. The resulting calculation of average land slope can be stored in a data repository or provided in a report, such as a map. Average land slopes, in some embodiments, may also be categorized based on their severity or sensitivity relative to flash flooding risk. To determine the categorization, historical sites, as discussed above, for flash flooding may be analyzed by calculating the average land slope for the catchment areas where the sites reside. The calculated values of the average land slopes then may be statistically analyzed to identify the categorization for average land slope values. As an example, FIG. 8 illustrates an example table of categories of flash flood risk based average land slope values based on the Manning formula. As illustrated, the impact of catchment slope on the flash flooding formation can be non-linear hydraulically. Based on the slope's contribution to the open channel flow in the Manning Equation listed in FIG. 8, the range of land slopes on flash flooding potential can be determined. Based on this range and the Manning equation, the flash flooding potential for different ranges of catchment slopes can be identified. A variety of other categorization methods are also contemplated by embodiments of the present invention. In some embodiments, as discussed above, one or more risk scores and/or indicators relating to the risk of flash flooding from land slope may be generated. The risk scores may be generated using the categorization process discussed above. For example, a risk score of “1” can be given to average land slope of less than 1 percent and a risk score of “10” for average land slop of higher than 30 percent as illustrated in FIG. 8. Other variations for generating risk scores are possible in embodiments the present invention.

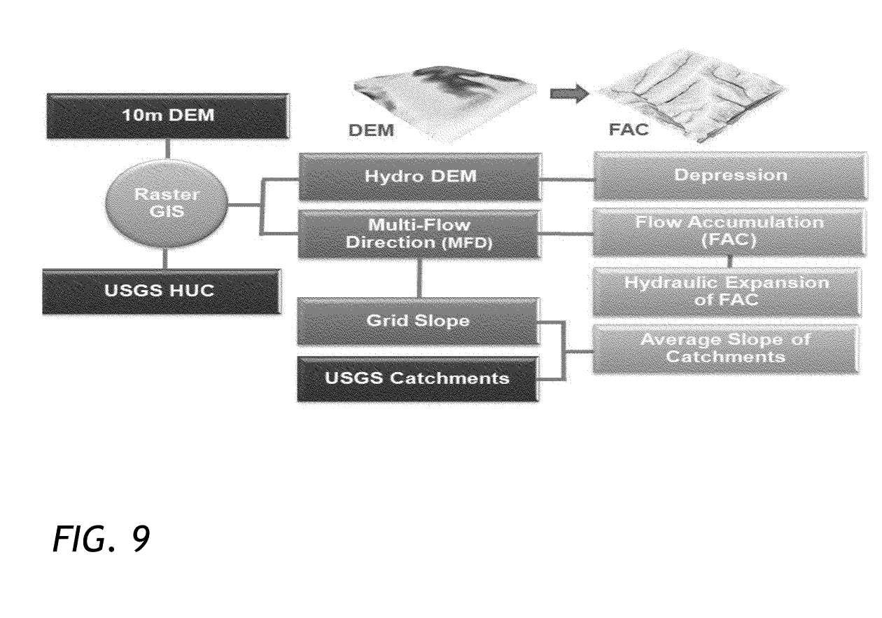

FIG. 9 illustrates a summary process for calculating flash flooding risks based on watershed hydrology characteristics and land slope characteristics discussed above. As illustrated, raster maps, such as 10 m DEM or USGS HUC, may be analyzed to calculate flow accumulation. In the illustrated example, a multi-flow direction process is shown. As also illustrated, the calculation of flow accumulation may be adjusted to account for hydraulic expansion. FIG. 9 also illustrates the calculation of average slope in catchment areas by analyzing the USGS catchment areas and the grid slopes for those areas.

Land Use

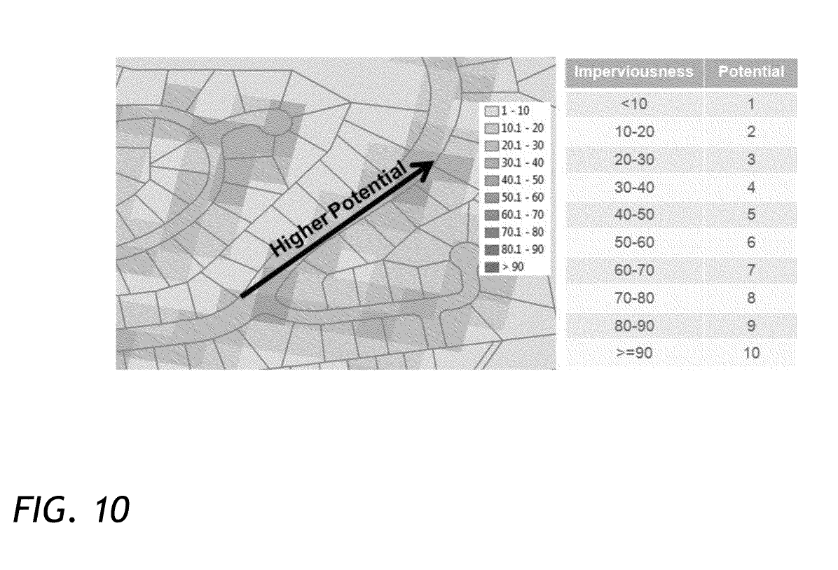

The urbanization and land use associated with communities have significant impact on imperviousness of land surface. The imperviousness difference between heavily developed areas and undeveloped areas could be very significant, and the difference can illustrate the magnitude of impact from human activities on flash flooding risks. Data sources, such as from USGS or NLCD, may be accessed to identify land use type and imperviousness characteristics. The resulting characteristics may also be categorized based on their severity or sensitivity relative to flash flooding risk. To determine the categorization, historical sites, as discussed above, for flash flooding may be analyzed by identifying the land use characteristics and statistically analyzing them to identify the categorization for land use characteristics. FIG. 10 illustrates an example table of categories of flash flood risk based on land use characteristics. As illustrated, higher the imperviousness of the land use, the higher the risk of flash flooding. A variety of other categorization methods are also contemplated by embodiments of the present invention. In some embodiments, as discussed above, one or more risk scores and/or indicators relating to the risk of flash flooding from land use characteristics may be generated. FIG. 10 illustrates examples of some risk scores based on the categorization process discussed above. Other variations for generating risk scores are possible in embodiments the present invention.

Soil Properties

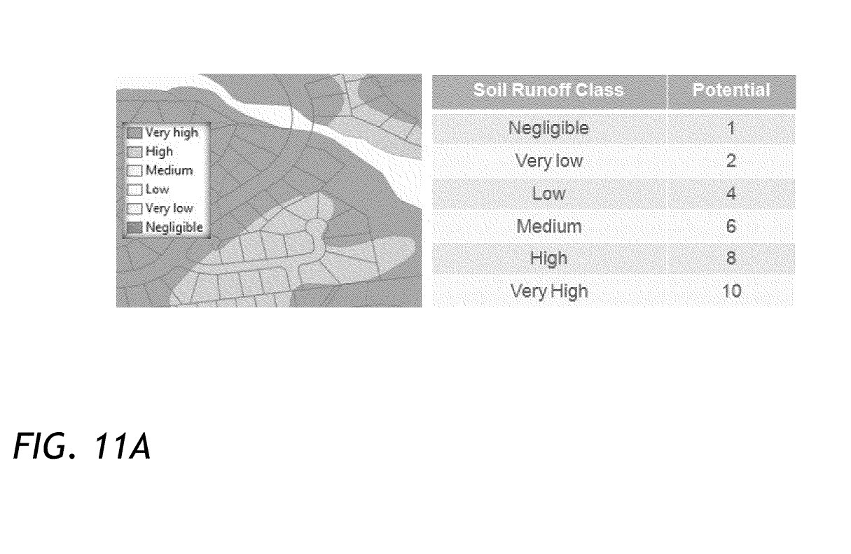

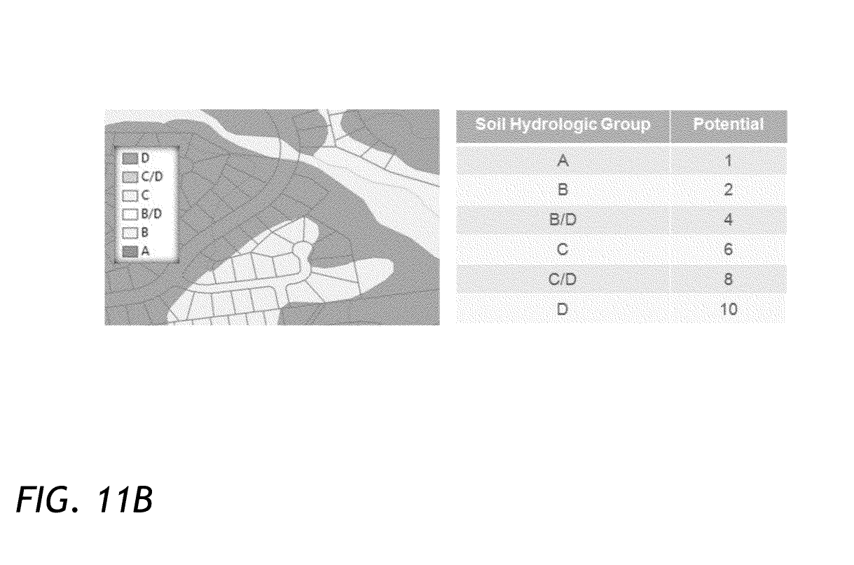

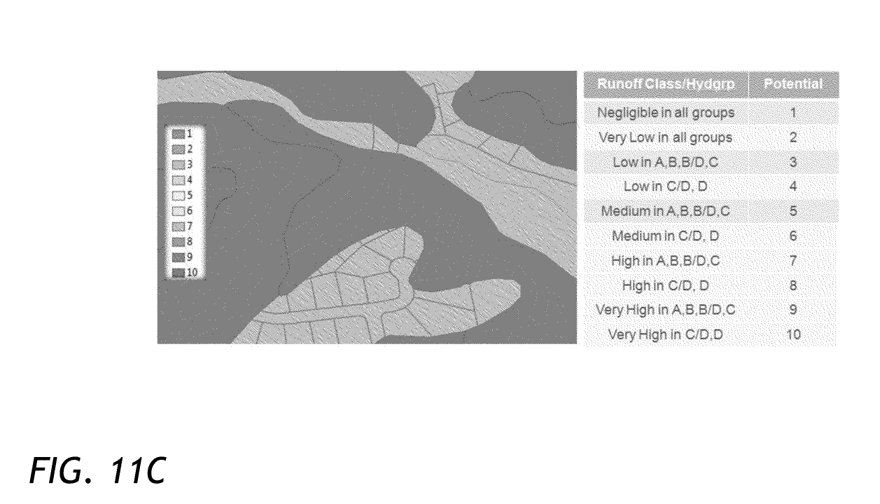

Different types of soils have different capabilities on water infiltration during rainfall events. As such, soil types (e.g., clay, rock, etc.) can control the amount of the surface runoff creation. In one embodiment, soil types may be statistically analyzed to identify its impact of flash flooding risk similar to the statistical analysis discussed above. Alternatively, in some embodiments, hydrologic properties of soils across all soil types can be used for classifying the flash flooding risk. For example, the Soil Survey Geographic (SSURGO) database from Natural Resource Conservation Service (NRCS) may be accessed and analyzed. FIG. 11 illustrates three examples of potential categories that may be identified by analyzing the SSURGO database.

FIG. 11A illustrates categorization based on use of RUNOFF CLASS of soils to identify the flash flooding potential. This attribute provides measurements of the surface runoff efficiency of soils. RUNOFF CLASS, as illustrated, contains 6 categories: Negligible, Very Low, Low, Medium, High and Very High. Because higher runoff potential leads to higher flash flooding potential, the categorization in FIG. 11A may be used. In some embodiments, as discussed above, one or more risk scores and/or indicators relating to the risk of flash flooding from soil properties may be generated. FIG. 11A also illustrates examples of some risk scores based on the categorization process discussed above. Other variations for generating risk scores are possible in embodiments the present invention.

FIG. 11B illustrates use of Hydrologic Group of soils to identify the flash flooding potential. Hydrologic Groups represent the infiltration capability of soils. Hydrologic Groups in the SSURGO database have 6 categories: A (high infiltration rates), B (moderate infiltration rates), B/D (moderate to slow infiltration rates), C (slow infiltration rates), C/D (slow to very slow infiltration rates), and D (very slow infiltration rates). Because higher infiltration rates lead to lower flash flooding potential, the categorization and/or risk scores in FIG. 11B may be used.

FIG. 11C illustrates use of a combination of the categorization from FIG. 11A and FIG. 11B to identify the flash flooding potential. The Runoff Class can be used as the control parameter as illustrated.

Forest and Vegetation Coverage

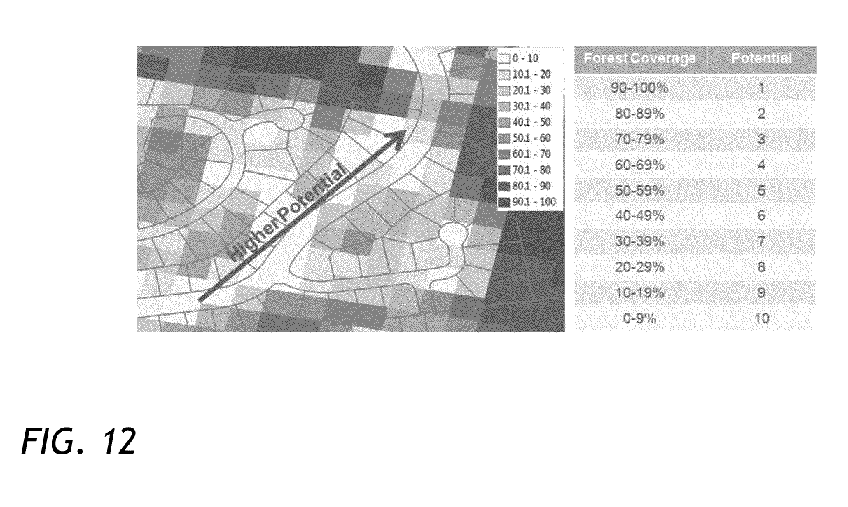

Forest and vegetation coverage can determine the amount of absorption of rainfall. In some embodiments, data sources, such as USGS National Landcover Database (NLCD) on Percent Tree Canopy, can used to identify the forest and vegetation coverage. Because higher forest and vegetation coverage can lead to smaller flash flooding potential, the categorization and/or risk scores in FIG. 12 may be used.

Land Depression Areas

Land depression areas can slow down the over-land-surface flow and promote flood water/depth accumulation: outgoing water volume< outgoing water volume during the flash flooding event. The land depression areas could become temporary storage places. Therefore, there may be higher flash flooding potential in the land depression areas. After the creation of hydro-DEMS (discussed above), the land depression area can be determined by subtracting elevation values in the filled hydro-DEM from the elevation values in the original DEM (e.g., the difference between the filled DEM and the original DEM). A score for the depression adjustment can then be added into overall flash flooding risk calculation.

Wildfire Burned Areas

When forest and vegetation are burned (e.g., from wildfires), absorption of rainfall can be reduced and, therefore, an increased risk for flash flooding may occur. Therefore, a small risk adjustment can be added into overall flash flooding risk calculation in the locations in wildfire burned areas.

Meteorological Conditions Determination

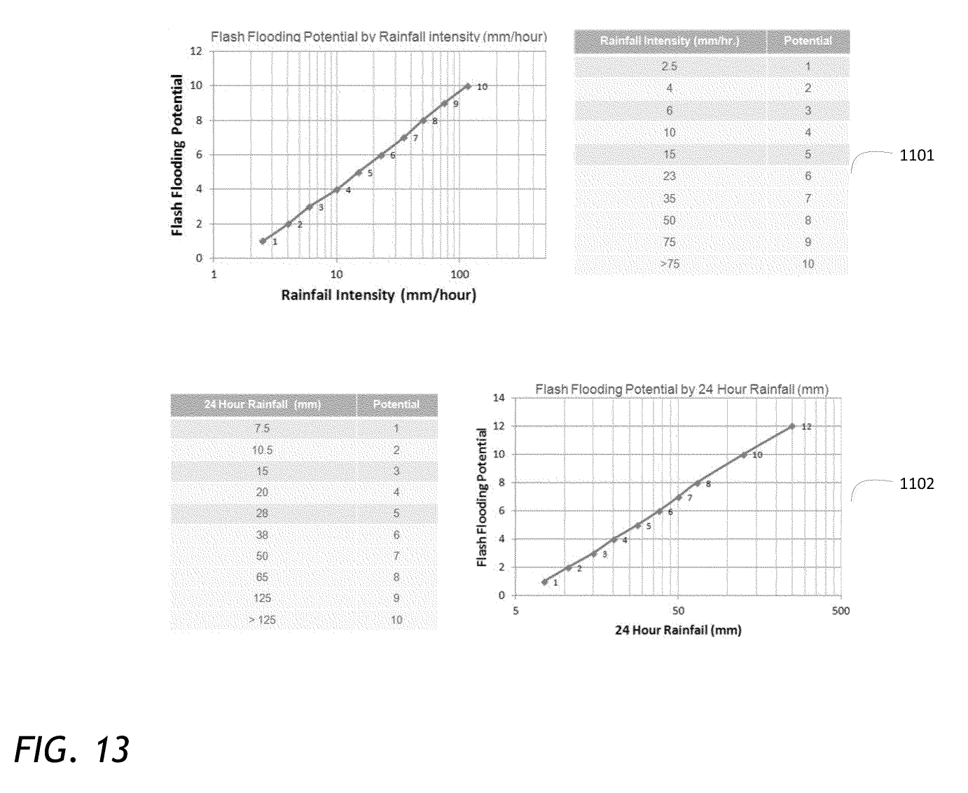

Application 46 may be configured to determine meteorological conditions that can be used to identify flash flood risks for real estate properties. Meteorological conditions can include any characteristics that may impact flash flood risks, such as rainfall volume, rainfall intensity, rainfall frequency, rainfall distribution, etc. For example, heavy rainfall can be the physical source for flash flooding hazards. Amount of rainfall volume over time period (rainfall intensity) can be an important indicator of the flash flooding potential. Higher rainfall intensity can lead to higher flash flooding potential. Since the relationship between rainfall intensity and its impact on flash flooding potential can be non-linear, logarithm curves can be used to scale the rainfall intensity intervals based on severity (such as very light, light, medium, heavy, and very heavy) of rainfall. FIG. 13 illustrates potential categorization and/or risk scores for rainfall intensity per hour 1101 and per 24 hours 1102 that can be used. A variety of other categorization methods are also contemplated by embodiments of the present invention.

As another example, the frequency of rainfall intensity can also be considered on determining the flash flooding risks. Areas with more frequent heavy rainfalls could have more frequent flash flooding problems. Historical rainfall data from data sources, such WSI and/or the Weather Channel Company can be used to compute flash flooding potential. The historical rainfall data then may be statistically analyzed to identify the categorization for rainfall frequency values. Example statistics that could be analyzed to determine its impact on flash flooding risks could include annual frequency of 1″, 2″, 3″ in an hour, annual frequency of 2″, 4″, 6″ in 3 hours, annual frequency of 4″, 8″, 12″ in 6 hours, mean 24 hour precipitation, standard deviation (“STD”) 24 hour precipitation, frequency of 1 hour events outside 1 STD 24 hour precipitation, frequency of 3 hour events outside 1 STD 24 hour precipitation, frequency of 6 hour events outside 1 STD 24 Hour Precipitation. A variety of other statistics could also be analyzed by embodiments of the present invention. The statistics can then be analyzed to identify categories identifying the effect of rain fall frequency of flash flooding potential, as discussed above.

Property Information Determination

Application 48 may be configured to determine property characteristics that can be used to identify flash flood risks for real estate properties. Property characteristics can include any characteristics that may impact flash flood risks, such as building structure, building architecture, etc. For example, if structures of properties are partially underground, hydraulically, it could contribute to flash flooding potential. Depending on the structures, flood water intrusion could happen from both the land surface level and the subsurface level when groundwater arises during heavy rainfall events. In some embodiments, a flash flooding risk adjustment for partial underground structure can be made.

### Example Real Estate Flash Flooding Risk Determination Process

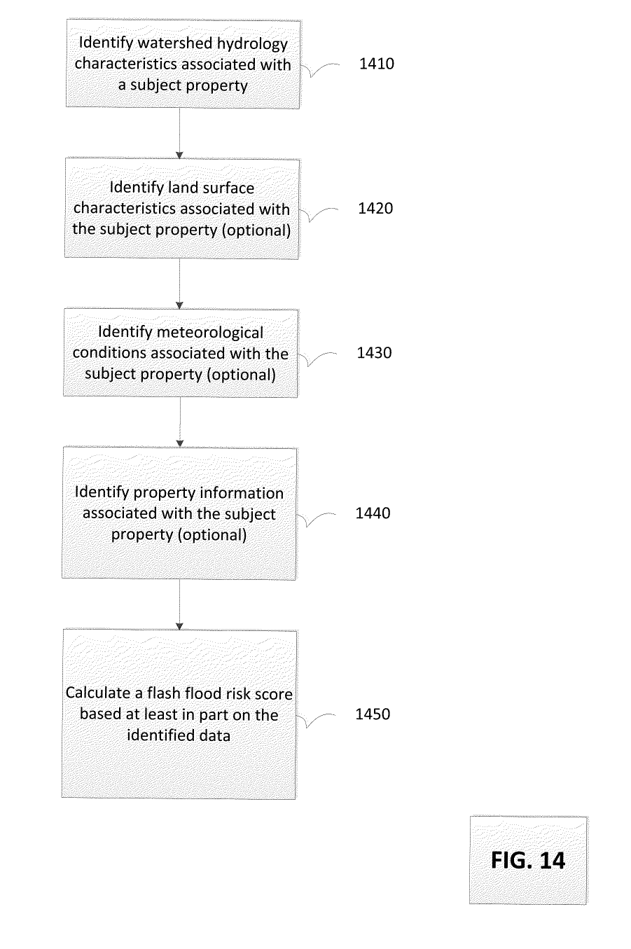

FIG. 14 illustrates one embodiment of an automated process that may be used by the flash flood assessment module 50 to identify flash flooding risks for real estate properties. In some embodiments, flash flooding risks may be provided as a quantitative identifier, such as a score, rank, range, etc., or a qualitative identifier, such as high, low, “A,” “C,” etc. As mentioned above, this process may be useful (as one example) for enabling an investor to decide whether to invest in a subject property.

As depicted by block 1410 of FIG. 14, the application 42 identifies watershed hydrology characteristics associated with a subject property. As discussed above, application 42 may communicate with data repository 36 to determine flow direction, flow accumulation, hydraulic expansion, etc. for the subject property. The contribution of the determined values on flash flooding potential may also be identified as discussed above.

As shown in block 1420 of FIG. 14, the application 44 then optionally identifies land surface characteristics associated with the subject property. Data repository 32 may be used to determine land slope, soil properties, imperviousness of land use, forest coverage, vegetation coverage, land depression areas, wildfire burned areas, etc. for the subject property. The contribution of the determined values on flash flooding potential may also be identified as discussed above

As depicted by blocks 1430 of FIG. 14, the application 46 then optionally identifies meteorological conditions associated with the subject property. Data repository 34 may be used to determine rainfall volume, rainfall intensity, rainfall frequency, frequency of rainfall intensity, rainfall distribution, etc. for the subject property. The contribution of the determined values on flash flooding potential may also be identified as discussed above

As depicted by blocks 1440 of FIG. 14, the application 48 then optionally identifies property information associated with the subject property. Data repository 30 may be used to determine building structure, building architecture, etc. for the subject property. The contribution of the determined values on flash flooding potential may also be identified as discussed above

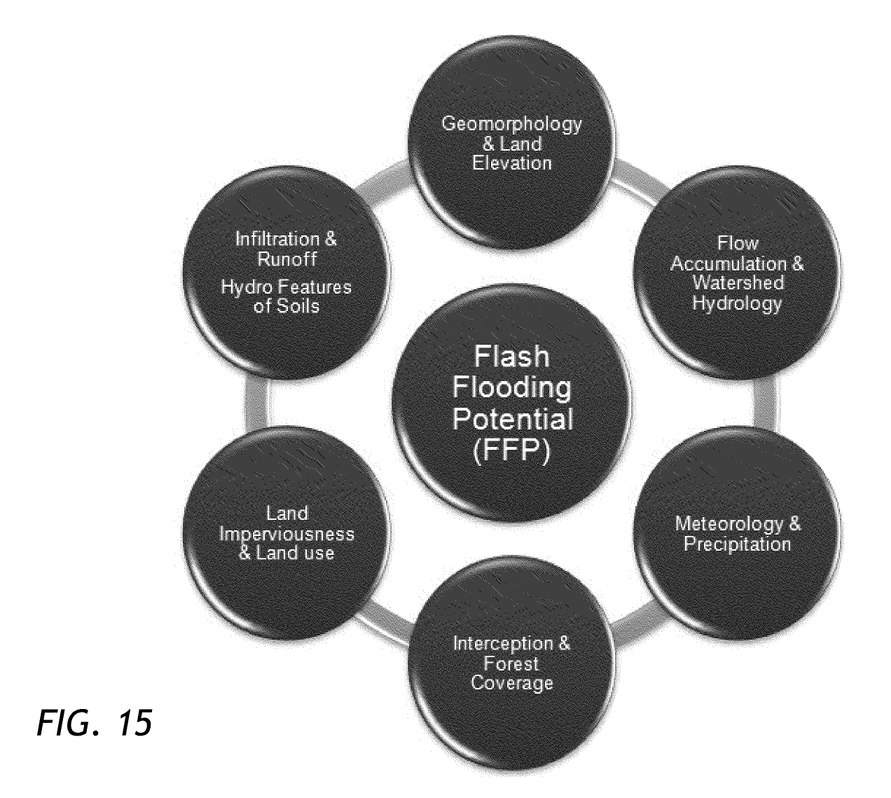

Subsequently, as depicted by blocks 1450 of FIG. 14, a flash flooding score may be computed based at least in part on the identified data, identified categories, and/or identified risk scores. FIG. 15 illustrates, by way of example, multiple factors discussed above that may be considered in computing a flash flooding score. Some of the factors can include but are not limited to: 1) Watershed Hydrology: flow accumulation and hydraulic expansion; 2) Land Surface: average catchment slope, land use type (Imperviousness), soil hydro features, forest coverage (Absorption), land depression, and wildfire burn factor); 3) Meteorological: frequency based rainfall intensity (Flood Source); 4) Property: building structure. The generated scores from the individual factors may also be processed, e.g., combined and/or mathematically manipulated into input features that will serve as input to the flash flooding model in use. An example input feature may be the maximum of two or more risk scores, e.g., max(risk score 1, risk score 2, . . . , risk score n). Another example input feature may be the average of several risk scores. In other embodiments, the risks scores may be combined by a weighted average. Initial weights for each factor discussed above may be assigned at random or may represent estimations. Changing the weight of the various factors may then result in better or worse models. Such modeling may be done by a number of well-known methods such as through the use of neural networks, logistic regression and the like. The approach may also be hands-on with statisticians or others aiding the modeling process or automated, such as with back propagation in a neural network to improve modeling.

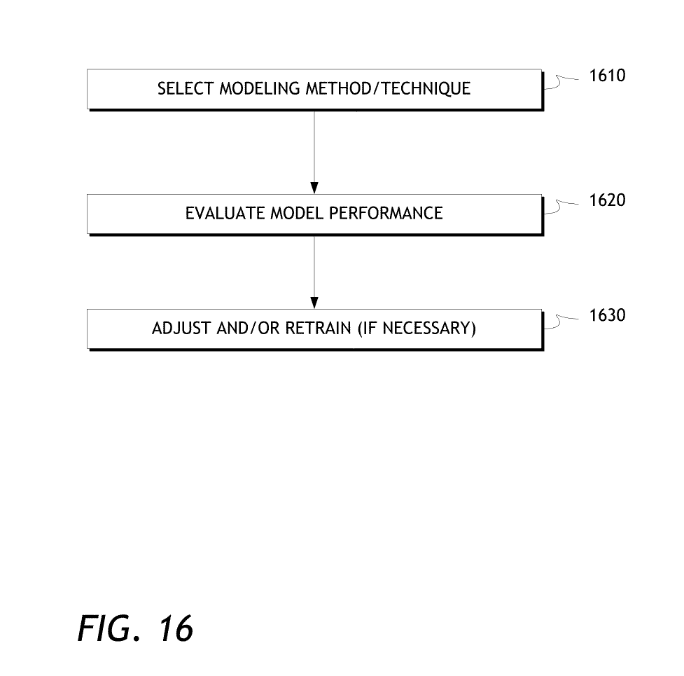

As depicted of FIG. 16, generating a flash flooding risk model includes selecting modeling method(s)/technique(s) (block 1610). Example modeling techniques may include but are not limited to linear regression, logistic regression, neural networks, support vector machines, decision trees, and their derivatives. Suitable modeling methods may include machine learning/data mining techniques including linear regression, logistic regression, neural networks, support vector machine, decision tree, etc. In practice, one technique can be used in the research effort to provide insights for another modeling technique. Thus a combination of techniques can be used in the analysis and in the product implementation.

As discussed above, suitable modeling methods include linear regression and/or logical regression. Linear regression is a widely used statistical method that can be used to predict a target variable using a linear combination of multiple input variables. Logistic regression is a generalized linear model applied to classification problems. It predicts log odds of a target event occurring using a linear combination of multiple input variables. These linear methods have the advantage of robustness and low computational complexity. These methods are also widely used to classify non-linear problems by encoding the nonlinearity into the input features. Although the mapping from the feature space to the output space is linear, the overall mapping from input variables through features to output is nonlinear and thus such techniques are able to classify the complex nonlinear boundaries. Desirably, the linear mapping between the feature space and the output space may make the final score easy to interpret for the end users.

Another suitable modeling method is neural networks. Logistic regression generally needs careful coding of feature values especially when complex nonlinear problems are involved. Such encoding needs good domain knowledge and in many cases involves trial-and-error efforts that could be time-consuming. A neural network has such nonlinearity classification/regression embedded in the network itself and can theoretically achieve universal approximation, meaning that it can classify any degree of complex problems if there is no limit on the size of the network. However, neural networks are more vulnerable to noise and it may be more difficult for the end users to interpret the results. In one embodiment, one suitable neural network structure is the feed-forward, back-prop, 1 hidden layer version. Neural networks may provide more robust models to be used in production environments when based on a larger data set than would be need to provide robust models from logistic regression. Also, the number of hidden nodes in the single hidden layer is important: too many nodes and the network will memorize the details of the specific training set and not be able to generalize to new data; too few nodes and the network will not be able to learn the training patterns very well and may not be able to perform adequately. Neural networks are often considered to be “black boxes” because of their intrinsic non-linearity. Hence, in embodiments where neural networks are used, when higher flash flooding risks are returned accompanying reasons are also provided. One such option is to provide flash flooding indicators in conjunction with scores generated by neural network based models, so that the end user can more fully understand the decisions behind the high flash flooding risks.

Embodiments may also include models that are based on support vector machines (SVMs). A SVM is a maximum margin classifier that involves solving a quadratic programming problem in the dual space. Since the margin is maximized, it will usually lead to low generalization error. One of the desirable features of SVMs is that such a model can cure the “curse of dimensionality” by implicit mapping of the input vectors into high-dimensional vectors through the use of kernel functions in the input space. A SVM can be a linear classifier to solve the nonlinear problem. Since all the nonlinear boundaries in the input space can be linear boundaries in the high-dimensional functional space, a linear classification in the functional space provides the nonlinear classification in the input space. It is to be recognized that such models may require very large volume of independent data when the input dimension is high.

Embodiments may also include models that are based on decision trees. Decision trees are generated using a machine learning algorithm that uses a tree-like graph to predict an outcome. Learning is accomplished by partitioning the source set into subsets using an attribute value in a recursive manner. This recursive partitioning is finished when pre-selected stopping criteria are met. A decision tree is initially designed to solve classification problems using categorical variables. It can also be extended to solve regression problem as well using regression trees. The Classification and Regression Tree (CART) methodology is one suitable approach to decision tree modeling. Depending on the tree structure, the compromise between granular classification, (which may have extremely good detection performance) and generalization, presents a challenge for the decision tree. Like logistic regression, results from decisions trees are easy to interpret for the end users.

Once the modeling method is determined, the flash flooding risk model is trained based on the historical data adaptively. The parameters of the model “learn” or automatically adjust to the behavioral patterns in the historical data and then generalize these patterns for detection purposes. When new flash flooding data is detected, the model will evaluate its flash flooding risk based on what it has learned in its training history. The modeling techniques for generating the flash flooding risk may be adjusted in the training process recursively.

The listing of modeling techniques provided herein are not exhaustive. Those skilled in art will appreciate that other predictive modeling techniques may be used in various embodiments. Example predictive modeling techniques may include Genetic Algorithms, Hidden Markov Models, Self Organizing Maps, Dynamic Bayesian Networks, Fuzzy Logic, and Time Series Analysis. In addition, in one embodiment, a combination of the aforementioned modeling techniques and other suitable modeling techniques may be used in the flash flooding risk model.

As depicted in block 1620 of FIG. 16, the performance of the flash flooding risk model may be evaluated in its predictive power and generalization prior to release to production. For example, in one embodiment the performance of a flash flooding risk model is evaluated on both the training dataset and the testing dataset, where the testing dataset is not used during the model development. The difference between the performance in the training data and the testing data demonstrates how robust the model is and how much the model is able to generalize to other datasets. The closer the two performances are, the more robust the model is.

Finally, at a block 1630, the flash flooding risk model may be adjusted and/or retrained as needed. For example, the flash flooding risk model may be adjusted to use a different modeling technique, based on the evaluation of the model performance. The adjusted flash flooding risk model may then be re-trained. In another example, the flash flooding risk model may be re-trained using updated and/or expanded data (e.g., flash flooding data) as they become available.

The outputs of the flash flooding model may be collected by application 50 to identify any flash flooding trends. The application 50 may collect flash flooding outputs from the generated flash flooding model at periodic intervals to identify flash flooding trends. The identified flash flooding outputs and/or trends may be stored or provided to interested parties, such as the computing device 26.

### Example Real Estate Valuation Determination Process

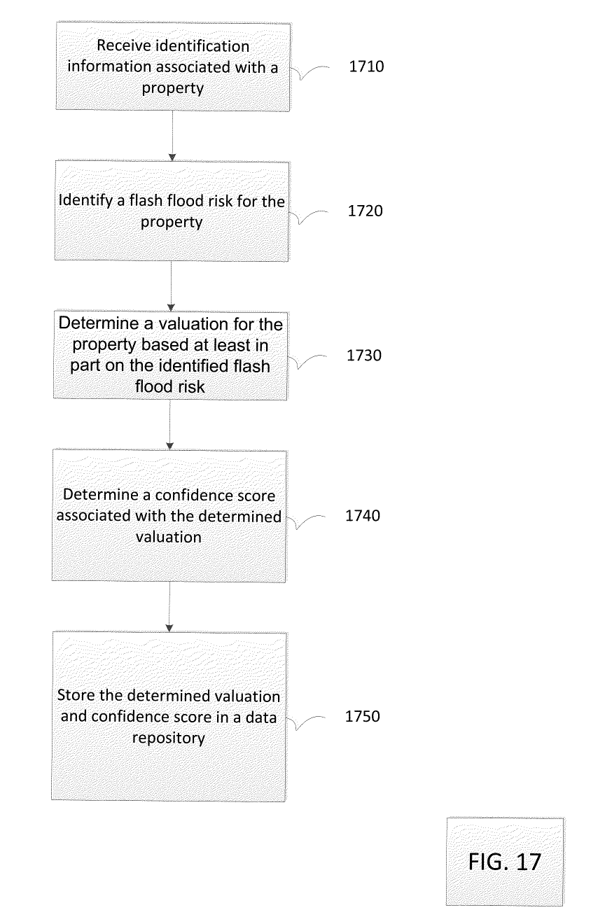

FIG. 17 illustrates one embodiment of an automated process that may be used by the analytics applications 22 to identify an automated valuation for real estate properties based in part on any identified flash flooding risks for the real estate properties. This process may be useful (as one example) for enabling a bank to decide how much a property is worth based on a subject property's flash flooding risk.

As depicted by block 1710 of FIG. 17, the analytics applications 22 initially receives identification information associated with a property (e.g., address, property owner identification, parcel number, etc.). Analytics applications 22 may communicate with computing device 26 to receive the identification information. The analytics applications 22 may then, in some embodiments, process the received identification information to uniquely identify the subject property of interest by, for example, communicating with data repository 30 or any other data repository to map the received identification information to the subject property.

As shown in block 1720 of FIG. 17, the analytics applications 22 then identifies a flash flooding risk or score associated with the property by accessing a flash flooding model. As discussed above, analytics applications 22 may communicate with application 50 to identify any flash flooding risks for the property based on the flash flooding model that was generated by application 50.

Subsequently, as depicted by blocks 1730 of FIG. 17, a valuation for the property based at least in part on the identified flash flooding risk or score may be identified. As explained above, an automated valuation model, such as a regression model, a neural network model, etc., may be generated using the identified flash flooding risk or score as an input along with any other desired inputs and an automated valuation as an output for the automated valuation model may be determined.

As depicted by blocks 1740 of FIG. 17, a confidence score associated with the determined automated valuation may be determined. The analytics applications 22 may generate an error model associated with the automated valuation determinations. The outputs from the error model may be identified and a confidence score determined. As depicted by block 1750 of FIG. 17, the determined valuation and confidence score may be stored in a data repository. In some embodiments, the determined valuation and confidence score may be provided to computing device 26.

### Example Real Estate Investment Metric Determination Process

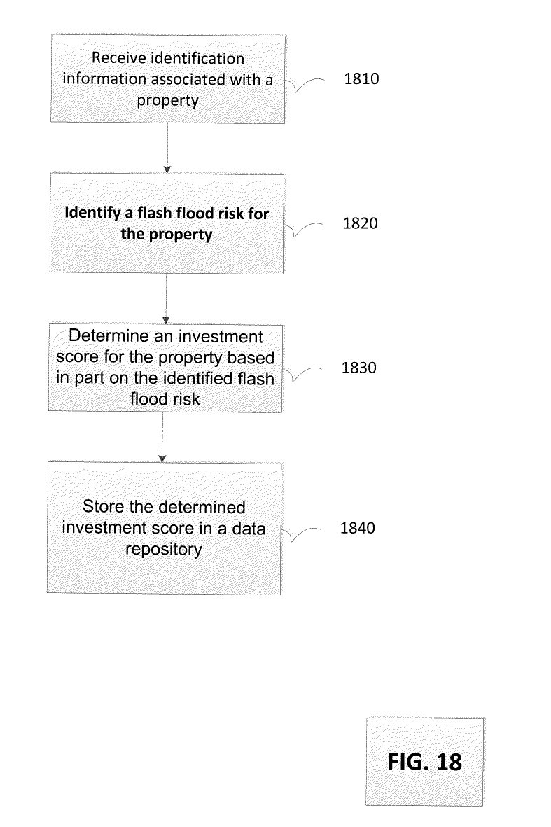

FIG. 18 illustrates one embodiment of an automated process that may be used by the analytics applications 22 to identify an investment metric for real estate properties based in part on any identified flash flooding risks for the real estate properties. The example in FIG. 18 relates to calculation of an investment score. An investment score can provide a ranking that quantifies the investment risk in a property. However, one skilled in the art will realize that the investment score is representative, and similar metrics may also be calculated based in part on the identified flash flooding risks. In this manner, investment metrics, including a risk score, default score, early payment score, and the like may be calculated based in part on the identified flash flooding risks. As mentioned above, this process may be useful (as one example) for enabling a lender to decide whether to provide a loan for a subject property.

As depicted by block 1710 of FIG. 17, the analytics applications 22 initially receives identification information associated with a property (e.g., address, property owner identification, parcel number, etc.). Analytics applications 22 may communicate with computing device 26 to receive the identification information. The analytics applications 22 may then, in some embodiments, process the received identification information to uniquely identify the subject property of interest by, for example, communicating with data repository 30 or any other data repository to map the received identification information to the subject property.

As shown in block 1720 of FIG. 17, the analytics applications 22 then identifies a flash flooding risk or score associated with the property by accessing a flash flooding model. As discussed above, analytics applications 22 may communicate with application 50 to identify any flash flooding risks or score for the property based on the flash flooding model that was generated by application 50.

Subsequently, as depicted by blocks 1730 of FIG. 17, an investment score for the property based at least in part on the identified flash flooding risk or score may be identified. As explained above, an investment score model, such as a regression model, a neural network model, etc., may be generated using the identified flash flooding risk or score as an input along with any other desired inputs and an investment score as an output for the investment model may be determined. The determined investment score may be stored in a data repository or may be provided to computing device 26.

### CONCLUSION

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the watershed hydrology determination application 42, land surface determination application 44, meteorological conditions determination application 46, property information determination application 48, flash flood assessment application 50, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-36, relational databases and flat file systems that use magnetic disk storage and/or solid state RAM. Some or all of the components shown in FIG. 1, such as those that are part of the Analytic System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A system comprising:
physical data storage configured to store watershed hydrology characteristics; and
a computer system in communication with the physical data storage, the computer system comprising computer hardware, the computer system programmed to:
receive identification information associated with a property;
determine a flow direction associated with the property based at least in part on the stored watershed hydrology characteristics;
determine a flow accumulation associated with the property based at least in part on the determined flow direction associated with the property;
generate a flash flood risk model based at least in part on the determined flow accumulation associated with the property;
calculate a flash flood risk score by applying the flash flood risk model to the property; and
store the calculated flash flood risk score in a data repository.

2. The system of claim 1, wherein the determined flow accumulation is adjusted to account for hydraulic expansion.

3. The system of claim 1, wherein the flash flood risk model comprises a regression model.

4. The system of claim 1, wherein the property comprises a vehicle.

5. The system of claim 1, wherein the flash flood risk model is further generated based at least in part on one or more of land surface characteristics, meteorological characteristics, or property characteristics associated with the property.

6. The system of claim 5, wherein the land surface characteristics comprise one or more of catchment slope, infiltration of soils, imperviousness of land use, or interceptions of forest coverage.

7. The system of claim 5, wherein the meteorological characteristics comprise rainfall intensity.

8. The system of claim 6, wherein the catchment slope comprises an average land slope of a catchment area associated with the property.

9. The system of claim 6, wherein the infiltration of soils comprises hydrologic properties associated with the soils across all soil types.

10. The system of claim 1, wherein the flow direction is determined in multiple directions.

11. A computer-implemented process comprising:
(a) providing identification information associated with a real estate property;
(b) requesting calculation of a flash flood risk score associated with the real estate property, wherein the flash flood risk score is calculated by applying a flash flood risk model to the real estate property, the flash flood risk model generated based at least in part on a determined flow direction and a determined flow accumulation associated with the real estate property;
(c) receiving the calculated flash flood risk score associated with the real estate property; and
(d) storing the calculated flash flood risk score in a data repository,
wherein steps (a)-(d) are performed by a computerized system that comprises one or more computing devices.

12. The process of claim 11, wherein the determined flow accumulation is adjusted to account for hydraulic expansion.

13. The process of claim 11, wherein the flash flood risk model is further generated based at least in part on one or more of land surface characteristics, meteorological characteristics, or property characteristics associated with the real estate property

14. The process of claim 13, wherein the land surface characteristics comprise one or more of catchment slope, infiltration of soils, imperviousness of land use, or interceptions of forest coverage.

15. The process of claim 13, wherein the meteorological characteristics comprise rainfall intensity.

16. The process of claim 14, wherein the catchment slope comprises an average land slope of a catchment area associated with the real estate property.

17. The process of claim 11, wherein the flash flood risk model comprises a regression model.

18. A computer-implemented process comprising:
(a) receiving identification information associated with a property;
(b) identifying a flash flooding risk associated with the property by providing the identification information to a flash flooding model;
(c) determining a valuation for the property based at least in part on the identified flash flooding risk; and
(d) determining a confidence score associated with the determined valuation;
(e) storing the determined valuation and the determined confidence score in a data repository,
wherein steps (a)-(e) are performed by a computerized analytics system that comprises one or more computing devices.

19. The process of claim 18, wherein the flash flooding model comprises a regression model.

20. The process of claim 18, wherein the confidence score is determined by application of an error model.
